(19) United States
(12) Patent Application Publication
(10) Pub. No.: US 2026/0219727 A1
(43) Pub. Date: Jul. 30, 2026

(54) METHOD AND APPARATUS FOR DISPLAYING IMAGE ON HEAD-MOUNTED DISPLAY DEVICE, DEVICE, AND MEDIUM

(71) Applicant: MATRIXED REALITY TECHNOLOGY CO., LTD., Wuxi (CN)

(72) Inventors: Wenqian Lai, Beijing (CN); Ruonan Guo, Beijing (CN); Kejian Wu, Beijing (CN)

(21) Appl. No.: 19/149,548

(22) PCT Filed: Jan. 19, 2024
(86) PCT No.: PCT/CN2024/073234

§ 371 Date: Jul. 20, 2025

(30) Foreign Application Priority Data
Jan. 20, 2023 (CN) 202310075149.5

(51) Int. Cl. G06F 3/01

(52) U.S. Cl. CPC G06F 3/011

(57) ABSTRACT

The present application discloses a method and apparatus for displaying an image on a head-mounted display device, a device, a medium and a product (1500). A specific implementation solution is as follows: determining a target operating mode (110) adapted to the head-mounted display device at the current time; if the target operating mode is a first preset operating mode, determining a first target orientation as an orientation (120) for processing a display image of the head-mounted display device; if the target operating mode is a second preset operating mode, determining a second target orientation as the orientation for processing the display image, wherein the second target orientation is determined based on the orientation error between a first estimated orientation and a second estimated orientation, wherein the second estimated orientation is an estimated orientation of the head-mounted display device in a reference coordinate system at a target historical time, the target historical time being a historical time that is closest to the current time among historical times (130) at which a corresponding target operating mode is the first preset operating mode; and based on the orientation for processing the display image, performing image display through the head-mounted display device (140).

The present disclosure claims priority to Chinese patent application No. CN202310075149.5, filed with the China National Intellectual Property Administration on Jan. 20, 2023, and entitled “Method and Apparatus for Displaying Image on Head-Mounted Display Device, Device and Medium”, which is incorporated herein by reference in its entirety.

### TECHNICAL FIELD

The present disclosure relates to the technical field of head-mounted display devices, in particular to a method and apparatus for displaying an image on a head-mounted display device, a device and a medium.

### BACKGROUND

Head-mounted display devices that adopt technologies such as augmented reality (AR) and virtual reality (VR) are being applied more and more widely. The head-mounted display devices can be used for content display, such as displaying movie images, game images, web pages, and so on

### SUMMARY

Embodiments of the present disclosure provide a method and apparatus for displaying an image on a head-mounted display device, a device and a medium.

According to an aspect of embodiments of the present disclosure, there is provided a method for displaying an image on a head-mounted display device, including: determining a target operating mode adapted to the head-mounted display device at the current time; in response to the target operating mode corresponding to the current time being a first preset operating mode, determining a first target orientation as an orientation for processing a display image of the head-mounted display device at the current time, wherein the first target orientation includes at least one of the following three items: a fixed orientation in the device coordinate system of the head-mounted display device, a corrected orientation in the device coordinate system at the current time, and an orientation for processing a display image of the head-mounted display device at the previous historical time relative to the current time; in response to the target operating mode corresponding to the current time being a second preset operating mode, determining a second target orientation in a reference coordinate system as the orientation for processing the display image of the head-mounted display device at the current time, wherein the second target orientation is determined based on the orientation error between a first estimated orientation and a second estimated orientation, wherein the first estimated orientation is an estimated orientation of the head-mounted display device in the reference coordinate system at the current time; and the second estimated orientation is an estimated orientation of the head-mounted display device in the reference coordinate system at a target historical time, the target historical time being a historical time that is closest to the current time among historical times at which a corresponding target operating mode is the first preset operating mode; and based on the orientation for processing the display image of the head-mounted display device at the current time, processing the display image of the head-mounted display device to perform image display through the head-mounted display device.

### BRIEF DESCRIPTION OF THE DRAWINGS

The above and other objects, features and advantages of the present disclosure will become more apparent from more detailed description of embodiments of the present disclosure in conjunction with the accompanying drawings. The accompanying drawings are used to provide further understanding of embodiments of the present disclosure, and form part of the specification, and are used, together with embodiments of the present disclosure, for explaining the present disclosure, but do not limit the present disclosure. In the accompanying drawings, same reference numerals usually represent same components or steps.

FIG. 1 is a flow diagram of a method for displaying an image on a head-mounted display device provided in an exemplary embodiment of the present disclosure.

FIG. 2a is a first schematic diagram of an operating mode of a head-mounted display device in an exemplary embodiment of the present disclosure.

FIG. 2b is a second schematic diagram of an operating mode of a head-mounted display device in an exemplary embodiment of the present disclosure.

FIG. 2c is a third schematic diagram of an operating mode of a head-mounted display device in an exemplary embodiment of the present disclosure.

FIG. 2d is a fourth schematic diagram of an operating mode of a head-mounted display device in an exemplary embodiment of the present disclosure.

FIG. 3 is a flow diagram of a method for displaying an image on a head-mounted display device according to another exemplary embodiment of the present disclosure.

FIG. 4 is a flow diagram of determining a target operating mode in an exemplary embodiment of the present disclosure.

FIG. 5 is a flow diagram of determining target information in an exemplary embodiment of the present disclosure.

FIG. 6 is a flow diagram of forcibly switching to a first preset operating mode in an exemplary embodiment of the present disclosure.

FIG. 7 is a flow diagram of determining a corrected orientation in an exemplary embodiment of the present disclosure.

FIG. 8 is a flow diagram of a method for displaying an image on a head-mounted display device provided in still another exemplary embodiment of the present disclosure.

FIG. 9 is a structural diagram of an apparatus for displaying an image on a head-mounted display device according to an exemplary embodiment of the present disclosure.

FIG. 10 is a structural diagram of an apparatus for displaying an image on a head-mounted display device according to another exemplary embodiment of the present disclosure.

FIG. 11 is a schematic diagram of a module for determining a target operating mode in an exemplary embodiment of the present disclosure.

FIG. 12 is a schematic diagram of modules for determining target information in an exemplary embodiment of the present disclosure.

FIG. 13 is a flow diagram of modules for forcibly switching to a first preset operating mode according to yet another exemplary embodiment of the present disclosure.

FIG. 14 is a schematic diagram of modules for determining a corrected orientation in an exemplary embodiment of the present disclosure.

FIG. 15 is a structural diagram of an electronic device according to an exemplary embodiment of the present disclosure.

### DETAILED DESCRIPTION

Exemplary embodiments according to the present disclosure will be described below in detail with reference to the accompanying drawings. Obviously, the described embodiments are only part of, instead of all of embodiments of the present disclosure. It should be understood that the present disclosure is not limited by the exemplary embodiments described here.

It is to be noted that unless specifically stated otherwise, the relative arrangement of components and steps, numerical expressions and numerical values set forth in these embodiments do not limit the scope of the present disclosure.

It may be understood by those skilled in the art that the terms “first”, “second” and the like in the embodiments of the present disclosure are only used to distinguish between different steps, devices or modules, etc., and do not represent any particular technical meaning or indicate an inevitable logical order thereof.

It should also be understood that in embodiments of the present disclosure, “plurality” may refer to two or more, and “at least one” may refer to one, two, or more.

It should also be understood that the number of any component, data, or structure mentioned in embodiments of the present disclosure may generally be understood to be one or more, unless explicitly defined or indicated otherwise by the context.

Additionally, the term “and/or” in the present disclosure merely represents an association relationship describing associated objects, indicating there may be three relationships. For example, A and/or B may indicate three situations: A exists alone; both A and B exist; and B exists alone. Additionally, the character “/” in the present disclosure generally indicates that the associated objects prior to and following it are in an “or” relationship.

It should also be understood that description of the various embodiments in the present disclosure emphasizes differences between the various embodiments. For their identical aspects or similarities, reference may be made to each other, and for the sake of brevity, they will not be described repeatedly.

The following description of at least one exemplary embodiment is actually only illustrative, and in no way serves as any limitation on the present disclosure and its application or use.

Technologies, methods, and devices known to those of ordinary skill in the related art may be not discussed in detail, but where appropriate, the technologies, methods, and devices should be regarded as part of the specification.

It should be noted that similar reference numerals and letters denote similar items in the following drawings, so once a certain item is defined in one drawing, it does not need to be further discussed in subsequent drawings.

Embodiments of the present disclosure may be applied to electronic devices such as terminal devices, computer systems, servers, etc., which may operate with numerous other general-purpose or specialized computing system environments or configurations. Examples of well-known terminal devices, computing systems, environments, and/or configurations suitable for use with electronic devices such as terminal devices, computer systems, servers, etc. include, but are not limited to: personal computer systems, server computer systems, thin clients, thick clients, handheld or laptop devices, microprocessor-based systems, set-top boxes, programmable consumer electronics, network personal computers, minicomputer systems, mainframe computer systems, and distributed cloud computing technology environments that include any system described above, and so on.

Electronic devices such as terminal devices, computer systems, servers, etc. may be described in the general context of computer system executable instructions (such as program modules) executed by a computer system. Typically, program modules include routines, programs, target programs, components, logic, data structures, etc., which perform specific tasks or implement specific abstract data types. The computer systems/servers may be implemented in a distributed cloud computing environment, in which tasks are performed by remote processing devices linked through a communication network. In the distributed cloud computing environment, the program modules may be located on a local or remote computing system storage medium that includes a storage device.

### Exemplary Overview

Generally, a head-mounted display (HMD) device can be used for image display. For example, movie images, video playback pages, etc. can be displayed through the head-mounted display device.

The head-mounted display device may also be referred to as a head-mounted display or HMD. The head-mounted display device may be used to achieve an extended reality (XR) effect, such as to achieve an augmented reality (AR) effect, a virtual reality (VR) effect, a mixed reality (MR) effect, etc. As the head-mounted display device can create a unique sense of immersion, a user can subjectively feel as if being in a space isolated from reality when using the head-mounted display device. This space may serve as a virtual space of the head-mounted display device.

It may be understood that the head-mounted display device may take the form of glasses, a helmet, etc. In some optional embodiments, the head-mounted display device may be in the form of a split machine, and the head-mounted display device in the form of a split machine requires an additional computing device. A head-mounted display device can be worn on the head of a user to display an image and the additional computing device may have at least one of a data processing capability and an image rendering capability. The computing device is communicatively connected to the head-mounted display device, and the computing device can provide data carrying the to-be-displayed images to the head-mounted display device. The head-mounted display device can use an optical system to display an image. The head-mounted display device can use sensors thereof to collect data, such as data collected by an inertial measurement unit (IMU), a camera, etc. The head-mounted display device may send the above-mentioned collected data to the computing device. The computing device uses the above-mentioned data to calculate at least one of a position, an orientation, or a pose of the head-mounted display device to process an image to be displayed. In some embodiments, the computing device may also determine a suitable operating mode for the head-mounted display device and, by processing the image to be displayed, cause the head-mounted display device to operate in the determined operating mode, so that the head-mounted display device achieves a display effect corresponding to the determined operating mode. In some embodiments, the computing device may also supply electrical power to the head-mounted display device. The head-mounted display device in the form of a split machine may also be communicatively connected to a control device for controlling the display image. The computing device itself may serve as the control device, or may also provide an additional control device, such that the control device is communicatively connected to at least one selected from the head-mounted display device and the computing device.

Optionally, the computing device may be a terminal device with computing capabilities, such as a mobile phone, an electronic computer, an adapter, or a central control system of a movable platform. The movable platform includes but is not limited to vehicles, trains, ships, airplanes, etc. Taking a vehicle as an example, the central control system may be a vehicle infotainment system (the vehicle infotainment system refers to an in-vehicle infotainment product mounted in a center console of a vehicle). A rendering engine may be mounted in the computing device.

The computing device may be a single terminal device or a plurality of terminal devices. For example, two terminal devices may serve as computing devices and may be communicatively connected to the head-mounted display device. The two terminal devices may include a first terminal device and a second terminal device, and the first terminal device and the second terminal device undertake part of the functions of the computing device according to actual requirements. For example, the first terminal device may be connected to the head-mounted display device via the second terminal device. The first terminal device may be primarily configured to provide data carrying the display image and electric power to the head-mounted display device. The first terminal device may also supply electric power to the second terminal device. The second terminal device may be configured to receive data collected by the sensors of the head-mounted display device, calculate at least one of the position, orientation, or pose of the head-mounted display device, and render images based on the above calculation results.

Optionally, the head-mounted display device and the computing device may interact via a wired communication method or a wireless communication method. For example, the head-mounted display device and the computing device may interact via Bluetooth, or the head-mounted display device and the computing device may interact via a universal serial bus (USB) interface.

Of course, the head-mounted display device may also be in the form of an all-in-one machine, and the head-mounted display device can simultaneously have capabilities including data collection, data processing, image rendering, and image display.

In some optional embodiments, additional control identifiers may also be displayed through the head-mounted display device. These control identifiers can facilitate interaction between the user and the display image in the virtual space.

Optionally, the control identifier may be a one-dimensional, two-dimensional, or three-dimensional identifier. The control identifier may be a dot, an arrow, a box, etc., or may also be an identifier with a certain length, such as a line segment, a curve, a long arrow, etc.

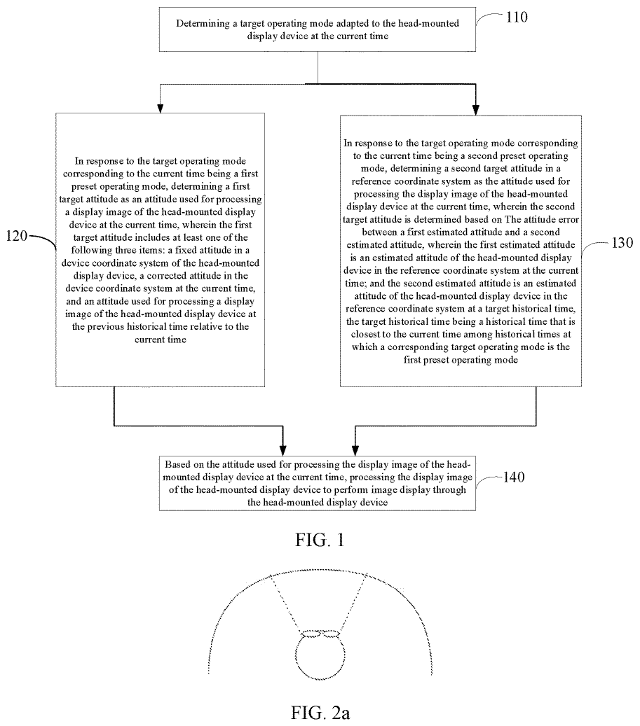

Exemplary method FIG. 1 is a flow diagram of a method for displaying an image on a head-mounted display device provided in an exemplary embodiment of the present disclosure. The method shown in FIG. 1 may include step 110, step 120, step 130, and step 140. The steps will be described below respectively.

Step 110: determining a target operating mode adapted to the head-mounted display device at a current time.

It is to be noted that the head-mounted display device may have at least two operating modes. The at least two operating modes may include a first preset operating mode and a second preset operating mode.

The first preset operating mode may be a mode that enables the display image to remain relatively stationary with respect to the head-mounted display device. In the first preset operating mode, the head-mounted display device may provide a 0dof (degree of freedom) display effect, i.e., providing an effect similar to that of direct screen projection through the head-mounted display device. Alternatively, the first preset operating mode may be a mode capable of achieving anti-jitter of the display image.

The second preset operating mode may be a mode that enables the display image to remain relatively stationary with respect to a specific object. In the second preset operating mode, the head-mounted display device may provide a 3dof display effect similar to that with the particular object as a reference.

In step 110, a suitable operating mode may be selected from at least two operating modes of the head-mounted display device as a target operating mode adapted to the head-mounted display device at the current time. The selected target operating mode may also be referred to as a target operating mode corresponding to the current time.

Step 120: in response to the target operating mode corresponding to the current time being a first preset operating mode, determining a first target orientation as an orientation for processing a display image of the head-mounted display device at the current time, wherein the first target orientation includes at least one of the following three items: a fixed orientation in a device coordinate system of the head-mounted display device, a corrected orientation in the device coordinate system at the current time, and an orientation for processing a display image of the head-mounted display device at the previous historical time relative to the current time.

It is to be noted that the presentation forms of the orientations involved in embodiments of the present disclosure include, but are not limited to, rotation matrices, quaternions, and Euler angles. For ease of understanding, the following description is provided by way of example in which an orientation is represented in the form of a rotation matrix.

In some optional implementations, the fixed orientation may be a fixed orientation in the device coordinate system of the head-mounted display device. The fixed orientation may be an orientation selected from a preset orientation range. The fixed orientation may be an orientation that conforms to the user's viewing habit, such as an orientation that enables the display image in the virtual space of the head-mounted display device to be perpendicular to the user's horizontal line of sight. In this way, the fixed orientation may be deemed as an orientation for processing a display image in order to ensure the display effect of the head-mounted display device.

In some optional implementations, the first target orientation may be the orientation for processing the display image of the head-mounted display device at the previous historical time relative to the current time. That is to say, the orientation for processing the display image of the head-mounted display device is consistent with the orientation at the previous historical time, and in the first preset operating mode, the first target orientation remains always consistent.

If the first target orientation is the fixed orientation or an orientation consistent with the previous historical time relative to the current time, the first preset operating mode may be deemed as a mode that enables the display image to remain relatively stationary with respect to the head-mounted display device.

In some optional implementations, the corrected orientation in the device coordinate system at the current time may also be referred to as a corrected orientation corresponding to the current time. The corrected orientation corresponding to the current time may be obtained by a certain orientation optimization algorithm. The orientation optimization algorithm includes, but is not limited to, the Kalman filtering algorithm, various variants of the Kalman filtering algorithm, and the least squares method. If the first target orientation is the corrected orientation corresponding to the current time, the first preset operating mode may be deemed as a mode capable of achieving anti-jitter of a display image.

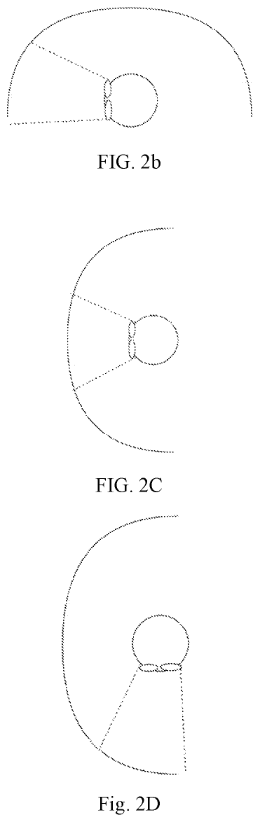

In the first preset operating mode, it may be understood as shown with reference to FIGS. 2a and 2c that the display image is substantially located directly in front of the user.

In step 120, in response to the target operating mode corresponding to the current time being the first preset operating mode, the head-mounted display device may be set to the first preset operating mode, and the first target orientation including at least one of the fixed orientation, the corrected orientation corresponding to the current time, and the orientation for processing the display image of the head-mounted display device at the previous historical time relative to the current time may be determined so as to set the first target orientation as the orientation for processing the display image of the head-mounted display device at the current time.

In some optional implementations, the processing of the display image of the head-mounted display device includes, but is not limited to, rendering, and adjustment. The adjustment here includes, but is not limited to, shifting, and warping.

Step 130: in response to the target operating mode corresponding to the current time being a second preset operating mode, determining a second target orientation in a reference coordinate system as the orientation for processing the display image of the head-mounted display device at the current time, wherein the second target orientation is determined based on an orientation error between a first estimated orientation and a second estimated orientation, wherein the first estimated orientation is an estimated orientation of the head-mounted display device in the reference coordinate system at the current time; and the second estimated orientation is an estimated orientation of the head-mounted display device in the reference coordinate system at a target historical time, the target historical time being a historical time that is closest to the current time among historical times at which a corresponding target operating mode is the first preset operating mode.

In some optional implementations, the reference coordinate system may include at least one of the following three items: a world coordinate system; a platform coordinate system of a movable platform where the head-mounted display device is located; and a portable device coordinate system of a portable device communicatively connected to the head-mounted display device.

If the reference coordinate system is the world coordinate system, the world coordinate system may be a three-dimensional coordinate system constructed with any suitable location as an origin according to an actual need.

If the reference coordinate system is the platform coordinate system of the movable platform where the head-mounted display device is located, the movable platform includes, but is not limited to, a vehicle, a ship, an airplane, a train, and an elevator, and the platform coordinate system of the movable platform may be a three-dimensional coordinate system constructed with a center of mass or another location point of the movable platform as an origin.

If the reference coordinate system is the portable device coordinate system of the portable device communicatively connected to the head-mounted display device, the portable device may be placed at any location according to the actual needs, and the portable device coordinate system of the portable device may be a three-dimensional coordinate system constructed with a center of mass or another location point of the portable device as an origin. Optionally, the portable device may be provided at a location of a vehicle, a ship, an airplane, a train, a user's body, a wall, a floor, etc., by means of a fixing structure such as a hook, a clip, a suction cup, and a magnet.

Since the reference coordinate system includes at least one of the world coordinate system, the platform coordinate system, and the portable device coordinate system, the use of the second preset operating mode can achieve, according to the user's actual need, an effect that the display image is stationary with respect to the world coordinate system, stationary with respect to the platform coordinate system, or stationary with respect to the portable device coordinate system.

In some optional implementations, an estimated orientation of the head-mounted display device in the reference coordinate system at any time may also be referred to an estimated orientation corresponding to the time or a true orientation corresponding to the time. The estimated orientation corresponding to any time may refer to an orientation of the head-mounted display device in a reference coordinate system estimated using data collected by an IMU provided in the head-mounted display device.

In some optional implementations, an operation of determining a target operating mode may be performed, and target operating modes corresponding to a plurality of historical times may be recorded. By arranging the target operating modes corresponding to the plurality of historical times in a chronological order, an operating mode sequence may be formed. In addition, based on the data collected by the IMU provided in the head-mounted display device, an operation of determining an estimated orientation may be performed to obtain and record estimated orientations corresponding to the plurality of historical times and the current time. By arranging the estimated orientations corresponding to the plurality of historical times and the current time in a chronological order, an estimated orientation sequence may be formed.

In step 130, in response to the target operating mode corresponding to the current time being the second preset operating mode, the head-mounted display device may be set to the second preset operating mode, and a first preset operating mode corresponding to the latest historical time may be determined from the operating mode sequence. The historical time corresponding to the determined first preset operating mode may be used as the target historical time. Next, from the estimated orientation sequence, the estimated orientation corresponding to the current time may be obtained as the first estimated orientation, and an estimated orientation corresponding to the target historical time may be obtained as the second estimated orientation. subsequently, the orientation error between the first estimated orientation and the second estimated orientation may be calculated by calculating a difference. Based on the orientation error between the first estimated orientation and the second estimated orientation, the second target orientation may be determined so as to use the second target orientation as the orientation for processing the display image of the head-mounted display device at the current time.

It is to be noted that since the second target orientation is determined with reference to the second estimated orientation, i.e., with reference to the estimated orientation of the head-mounted display device in the reference coordinate system at the last time in the first preset operating mode immediately preceding the second preset operating mode, the second preset operating mode implemented in the present disclosure is different from an ordinary 3dof mode, but is instead a 3dof mode that takes into account the second estimated orientation. The ordinary 3dof mode do not take into account the second estimated orientation defined by the present disclosure.

In the second preset operating mode, it may be understood as an effect illustrated with reference to FIGS. 2b and 2d. Relative to the first preset operating mode, the user's field of view deviates from a field of view area of the first preset operating mode, and if the display image is relatively large, other display image areas can be viewed, as shown in FIGS. 2b and 2d. If the display image is relatively small, the user can observe the real world.

It is to be noted that the difference calculation in embodiments of the present disclosure may not be limited to simple subtraction, but may be implemented as a generalized function, which may be used to calculate a difference between different input quantities.

Step 140: based on the orientation for processing the display image of the head-mounted display device at the current time, processing the display image of the head-mounted display device to perform image display through the head-mounted display device.

In some optional implementations, a rendering engine of the head-mounted display device may perform processing such as rendering and adjustment on an image to be displayed of the head-mounted display device with reference to the orientation for processing the display image of the head-mounted display device at the current time, and update a processing result of the image to be displayed to a display screen of the head-mounted display device for display.

In other optional implementations, a display position of the image to be displayed on the display screen of the head-mounted display device may be adjusted with reference to the orientation for processing the display image of the head-mounted display device at the current time.

In embodiments of the present disclosure, the target operating mode adapted to the head-mounted display device at the current time may be determined. In the case where the target operating mode corresponding to the current time is the first preset operating mode, the first target orientation may be used for the processing of the display image of the head-mounted display device at the current time, thereby enabling the display image to remain relatively stationary with respect to the head-mounted display device, or achieving anti-jitter of the display image. In this way, the display image can conform to the user's viewing habit, thereby improving the user experience when the user watches videos (e.g., watching a movie), and saving computational resources; or the image stability of the head-mounted display device can be ensured through the use of an anti-jitter algorithms, in order to improve the user experience when the user watches videos. In the case where the target operating mode corresponding to the current time is the second preset operating mode, an estimated orientation associated with the first preset operating mode (e.g., the second estimated orientation above) may be used for the determination of the second target orientation, and the second target orientation may be used for the processing of the display image of the head-mounted display device at the current time, thereby enabling the display image to remain relatively stationary with respect to the reference coordinate system. This can satisfy the user's need to view the outside real world when watching videos, and avoid blocking of the user's line of sight by the display image, or eliminate the need to adjust his or her head orientation in order to see an image that cannot be seen at the current orientation because the display image is beyond the user's field of view. Therefore, adopting embodiments of the present disclosure can both improve the user experience when the user watches videos, and well satisfy the real need of the user.

In some optional examples, a first multiplication result of an inverse matrix of the second estimated orientation and the first estimated orientation is used to characterize the orientation error between the first estimated orientation and the second estimated orientation, and the second target orientation satisfies one of the following two conditions:
the first target orientation is the orientation used for processing the display image of the head-mounted display device at the previous historical time relative to the current time, and a second multiplication result of the first target orientation and the first multiplication result is used as the second target orientation; and
the first target orientation is the fixed orientation in the device coordinate system of the head-mounted display device, the first target orientation is an identity matrix, and the first multiplication result is used as the second target orientation.

Assuming that the first estimated orientation is denoted as R_{T}^{t} and the second estimated orientation is denoted as R₀^{t}, then the inverse matrix of the second estimated orientation may be denoted as

$${( {R}_{0}^{t} )}^{- 1} ,$$

and the first multiplication result of the inverse matrix of the second estimated orientation and the first estimated orientation may be denoted as

$${( {R}_{0}^{t} )}^{- 1} {R}_{T}^{t} , {where ( {R}_{0}^{t} )}^{- 1} {R}_{T}^{t}$$

denotes a orientation error in the reference coordinate system. Assuming that the first target orientation is denoted as R₀ and the second target orientation is denoted as R_{T}, then:
if the first target orientation is the orientation for processing the display image of the head-mounted display device at the previous historical time relative to the current time, then

$${R}_{T} = {{R}_{0} ( {R}_{0}^{t} )}^{- 1} {R}_{T}^{t} ;$$

and
if the first target orientation is the fixed orientation in the device coordinate system of the head-mounted display device, and the first target orientation is an identity matrix, then

$${R}_{T} = {( {R}_{0}^{t} )}^{- 1} {R}_{T}^{t} .$$

For example, assuming that FIGS. 2a to 2d illustrate chronologically sequential changes, then in the first preset operating mode shown in FIG. 2a, the first target orientation R₀ is an identity matrix. In the second preset operating mode shown in FIG. 2b, the second target orientation is

$${R}_{T} = {( {R}_{0}^{t} )}^{- 1} {R}_{T}^{t} .$$

operating mode shown in FIG. 2c, the first target orientation R₀′ is the orientation for processing the display image of the head-mounted display device at the previous historical time relative to the current time, and the R₀′ is not an identity matrix but R_{T}. That is, in the second preset operating mode shown in FIG. 2d, the second multiplication result of the first target orientation and the first multiplication result can be used as the second target orientation, and the second target orientation is

$${R}_{T}^{′} = {{R}_{0}^{′} ( {R}_{0}^{t ′} )}^{- 1} {R}_{T}^{t ′} .$$

In embodiments of the present disclosure, by means of the simple matrix inversion and matrix multiplication operations, the second target orientation can be efficiently and reliably calculated so as to be used for the processing of the display image of the head-mounted display device at the current time.

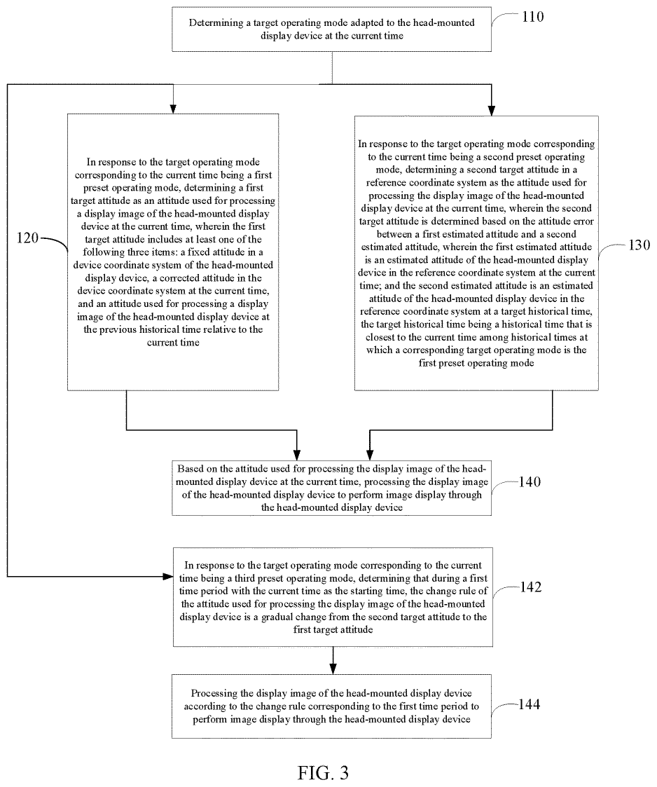

Based on the embodiment shown in FIG. 1, after step 110, the method according to embodiments of the present disclosure further includes steps 142 and 144, as shown in FIG. 3.

Step 142: in response to the target operating mode corresponding to the current time being a third preset operating mode, determining that during a first time period with the current time as a starting time, a change rule of the orientation for processing the display image of the head-mounted display device is a gradual change from the second target orientation to the first target orientation.

Step 144: processing the display image of the head-mounted display device according to the change rule corresponding to the first time period to perform image display through the head-mounted display device.

It is to be noted that in addition to the first preset operating mode and the second preset operating mode, the at least two operating modes of the head-mounted display device may include a third preset operating mode. The third preset operating mode may be a transition mode from the second preset operating mode to the first preset operating mode.

In some optional implementations, during the gradual change from the second target orientation to the first target orientation, the orientation for processing the display image of the head-mounted display device may change linearly (e.g., in the form of a linear function) or nonlinearly (e.g., in the form of a quadratic function).

If the orientation for processing the display image of the head-mounted display device changes linearly, a duration of the first time period may be a fixed duration set in advance. Based on an orientation difference between the second target orientation and the first target orientation, and the duration of the first time period, a slope for the linear change of the orientation may be determined. Subsequently, the gradual change of the orientation may be implemented based on the determined slope.

Alternatively, if the orientation for processing the display image of the head-mounted display device changes linearly, a slope for the linear change of the orientation may be set in advance, and the gradual change of the orientation may be implemented based on the slope set in advance. In this case, the first time period is not of a fixed duration, but is determined by the magnitude of the slope set in advance.

In embodiments of the present disclosure, by gradually changing the orientation for processing the display image of the head-mounted display device from the second target orientation to the first target orientation, the orientation changes relatively slowly, which helps avoid substantial jitter in the display image. Furthermore, through the orientation change, the orientation for processing the display image of the head-mounted display device can finally return to the orientation in the first preset operating mode (i.e., the first target orientation), which helps improves the user experience when the user watches videos.

Of course, the orientation for processing the display image of the head-mounted display device may alternatively switch directly from the second target orientation to the first target orientation, rather than changing gradually, which is also feasible.

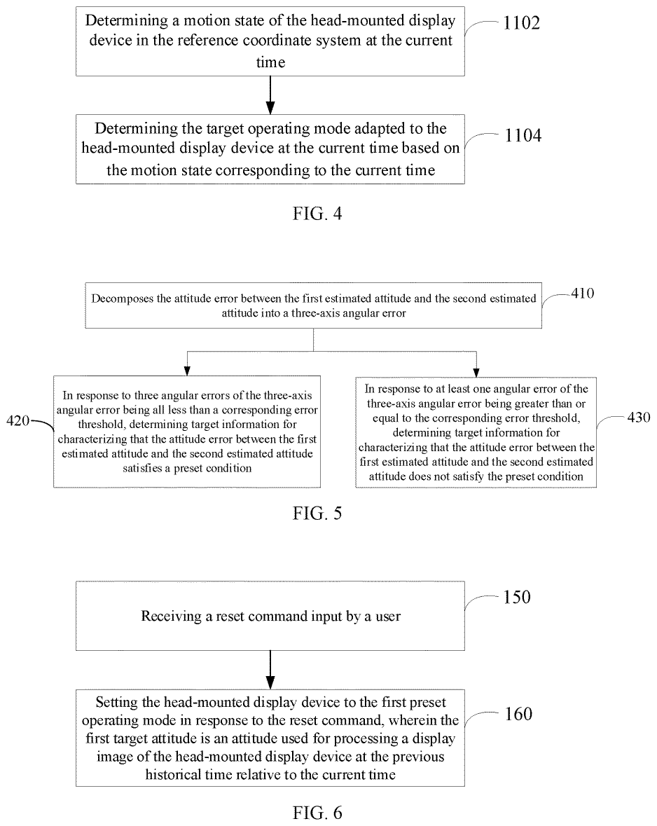

In some optional examples, as shown in FIG. 4, step 110 may include steps 1102 and 1104.

Step 1102: determining a motion state of the head-mounted display device in the reference coordinate system at the current time.

In some optional implementations, the motion state of the head-mounted display device in the reference coordinate system includes, but is not limited to, a stationary state, a uniform linear motion state, an accelerated motion state, and decelerated motion state. The accelerated motion state may be further subdivided into a uniformly accelerated motion state and a variably accelerated motion state. The decelerated motion state may be further subdivided into a uniformly decelerated motion state and a variably decelerated motion state.

In other optional implementations, the motion state of the head-mounted display device in the world coordinate system includes, but is not limited to, a first preset motion state, a second preset motion state, and a third preset motion state described below. The first preset motion state may represent a small-amplitude motion. The second preset motion state may represent a short-time large-amplitude motion. The third preset motion state may represent a long-time large-amplitude motion.

It is to be noted that the motion state of the head-mounted display device in the reference coordinate system at any time may also be referred to as a motion state corresponding to the time.

In some optional implementations, step 1102 includes:
in response to three angular velocities of a three-axis angular velocity of the head-mounted display device in the reference coordinate system at the current time being all less than or equal to corresponding angular velocity thresholds, using a first preset motion state as the motion state corresponding to the current time;
in response to at least one angular velocity of the three-axis angular velocity of the head-mounted display device in the reference coordinate system being greater than a corresponding angular velocity threshold during a second time period with the current time as an ending time, using a second preset motion state as the motion state corresponding to the current time, wherein a duration of the second time period is less than a preset duration; and
in response to at least one angular velocity of the three-axis angular velocity of the head-mounted display device in the reference coordinate system being greater than a corresponding angular velocity threshold during a third time period with the current time as an ending time, using a third preset motion state as the motion state corresponding to the current time, wherein a duration of the third time period is greater than or equal to the preset duration.

Optionally, the preset duration may be 30 milliseconds, 50 milliseconds, 0.5 seconds, 1 second, or other values, which are not enumerated herein.

It is to be noted that the three-axis angular velocity of the head-mounted display device in the reference coordinate system at any time may be calculated based on an estimated orientation sequence or calculated based on data collected by the IMU or other motion sensors provided in the head-mounted display device, which is not limited in any way by embodiments of the present disclosure. The three-axis angular velocity of the head-mounted display device in the reference coordinate system at any time may include: an angular velocity ωₓ along an X-axis of the reference coordinate system, an angular velocity ω_{y} along a Y-axis of the reference coordinate system, and an angular velocity ω_{z} along a Z-axis of the reference coordinate system. In addition, the angular velocity threshold thrₓ may be set in advance for the X-axis of the reference coordinate system, an angular velocity threshold thr_{y} for the Y-axis of the reference coordinate system, and an angular velocity threshold thr_{z} for the Z-axis of the reference coordinate system.

If ωₓ corresponding to the current time is less than or equal to thrₓ, ω_{y} corresponding to the current time is less than or equal to thr_{y}, and ω_{z} corresponding to the current time is less than or equal to thr_{z}, it may be determined that the head-mounted display device is in a small-amplitude motion, and accordingly, the first preset motion state may be used as the motion state corresponding to the current time.

If at least part of times in the second time period with the current time as the ending time satisfy that a corresponding ωₓ is greater than thrₓ, or a corresponding ω_{y} is greater than thr_{y}, or a corresponding Oz is greater than thr_{z}, it may be determined that the head-mounted display device is in a large-amplitude motion. Furthermore, since the second time period is less than the preset duration, it may be determined that a duration of the large-amplitude motion of the head-mounted display device is not enough, and thus, the second preset motion state may be used as the motion state corresponding to the current time. In specific implementation, if at least part of the times satisfies the above-mentioned condition, which may be some of the times satisfying the above-mentioned condition, or may be the vast majority of the times satisfying the above-mentioned condition, or may be all of the times satisfying the above-mentioned condition, then the second preset motion state is used as the motion state corresponding to the current time. Alternatively, a first average value of ωₓ corresponding to at least part of the times within the second time period, a second average value of ω_{y} corresponding to at least part of the times, and a third average value of ω_{z} corresponding to at least part of the times may be calculated, and if the first average value is greater than thrₓ, or the second average value is greater than thr_{y}, or the third average value is greater than thr_{z}, the second preset motion state may also be used as the motion state corresponding to the current time.

If at least part of times in the third time period with the current time as the ending time satisfy that a corresponding ωₓ is greater than thrₓ, or a corresponding ω_{y} is greater than thr_{y}, or a corresponding ω_{z} is greater than thr_{z}, it may be determined that the head-mounted display device is in a large-amplitude motion. Furthermore, since the third time period is greater than or equal to the preset duration, it may be determined that a duration of the large-amplitude motion of the head-mounted display device is enough, and thus, the third preset motion state may be used as the motion state corresponding to the current time. Similar to the above paragraph, in specific implementation, if at least part of the times satisfies the above-mentioned condition, which may be understood as described above, or any of the average values corresponding to ωₓ, ω_{y}, and ω_{z} satisfies the corresponding condition, the third preset motion state may also be used as the motion state corresponding to the current time.

In such implementations, by comparing each angular velocity of the three-axis angular velocity of the head-mounted display device in the reference coordinate system with the corresponding angular velocity threshold, the motion amplitude of the head-mounted display device can be efficiently assessed, and through the use of the durations (e.g., the duration of the second time period and the duration of the third time period in the above description), the corresponding motion state can be efficiently and reasonably determined for the current time.

Of course, in specific implementation, the manner of determining the motion state corresponding to the current time is not limited to this. For example, the determination of the motion state may be performed with reference to an average velocity of the head-mounted display device over a period of time, or the determination of the motion state may be performed in conjunction with the average velocity of the head-mounted display device over a period of time and the results of comparing the angular velocities of the three-axis angular velocity respectively with the corresponding angular velocity thresholds.

step 1104: determining the target operating mode adapted to the head-mounted display device at the current time based on the motion state corresponding to the current time.

In some optional examples, step 1104 includes:
determining the target operating mode corresponding to the current time based on the motion state corresponding to the current time and mode determination reference information, wherein the mode determination reference information includes at least one of the following three items: a target operating mode corresponding to the previous historical time relative to the current time, a motion state corresponding to the previous historical time relative to the current time, and target information used to characterize whether the orientation error between the first estimated orientation and the second estimated orientation satisfies a preset condition.

It is to be noted that the target operating mode corresponding to the previous historical time relative to the current time may be obtained from the operating mode sequence described above. The motion state corresponding to the previous historical time relative to the current time may be obtained from a motion state sequence. For the manner of generating the motion state sequence, reference may be made to the above description of the manner of generating the operating mode sequence, which will not be repeated here. Whether the orientation error between the first estimated orientation and the second estimated orientation satisfies the preset condition may mean: whether the first estimated orientation is sufficiently close to the second estimated orientation. If the first estimated orientation is sufficiently close to the second estimated orientation, the target information may be expressed as “1”. If the first estimated orientation is not sufficiently close to the second estimated orientation, the target information may be expressed as “0”.

In some optional implementations, determining the target operating mode corresponding to the current time based on the motion state corresponding to the current time and mode determination reference information includes one of the following two items:
in response to the motion state corresponding to the current time being the first preset motion state and the target operating mode corresponding to the previous historical time relative to the current time being the first preset operating mode, using the first preset operating mode as the target operating mode corresponding to the current time; and
in response to the motion state corresponding to the current time being the first preset motion state, the target operating mode corresponding to the previous historical time relative to the current time being the third preset operating mode, and the fact that for the target operating mode corresponding to the previous historical time relative to the current time, a change in the orientation for processing the display image of the head-mounted display device according to a corresponding change rule has completed, using the first preset operating mode as the target operating mode corresponding to the current time.

It may be understood that the expression “a change in the orientation according to a corresponding change rule has completed” may mean that the change in the orientation according to the corresponding change rule is substantially close to completion, and may mean that the orientation has substantially changed from a second target orientation in the second preset operating mode to immediately close to or substantially to a first target orientation in the adjacent first preset operating mode preceding the second preset operating mode. The adjacent first preset operating mode preceding the second preset operating mode may be understood as a first preset operating mode before switching to the present second preset operating mode.

If the motion state corresponding to the current time is the first preset motion state, and the target operating mode corresponding to the previous historical time relative to the current time is the first preset operating mode, it indicates that the head-mounted display device at the current time is in a small-amplitude motion, and the user does not have the need to view the outside real world or view an image that cannot be seen at the current orientation. Thus, the first preset operating mode suitable for watching videos may be directly used as the target operating mode corresponding to the current time, so that the operating mode of the head-mounted display device continues to maintain the first preset operating mode, thereby ensuring the user experience when the user watches the videos.

If the motion state corresponding to the current time is the first preset motion state, it indicates that the head-mounted display device is in a small-amplitude motion at the current time. If the target operating mode corresponding to the previous historical time relative to the current time is the third preset operating mode, and for the target operating mode corresponding to the previous historical time relative to the current time, a change in the orientation used for processing the display image of the head-mounted display device according to a corresponding change rule has completed, it indicates that the user has substantially returned to an orientation at the time of switching to the second preset operating mode, and the user no longer needs to view the outside real world or view an image that cannot be seen in the first preset operating mode, but wants to return to a state before mode switching. Since the orientation for processing the display image of the head-mounted display device has changed to a target orientation at the time of switching from the first preset operating mode to the second preset operating mode, the first preset operating mode suitable for watching videos may be used as the target operating mode corresponding to the current time. The use of the first preset operating mode can ensure the user experience when the user views videos.

In other optional implementations, determining the target operating mode corresponding to the current time based on the motion state corresponding to the current time and mode determination reference information includes one of the following two items:
in response to the motion state corresponding to the current time being the first preset motion state and the motion state corresponding to the previous historical time relative to the current time being the second preset motion state, using the third preset operating mode as the target operating mode corresponding to the current time; and
in response to the motion state corresponding to the current time being the first preset motion state, the motion state corresponding to the previous historical time relative to the current time being the third preset motion state, and the target information characterizing the orientation error between the first estimated orientation and the second estimated orientation as satisfying the preset condition, using the third preset operating mode as the target operating mode corresponding to the current time.

If the motion state corresponding to the current time is the first preset motion state and the motion state corresponding to the previous historical time relative to the current time is the second preset motion state, it indicates that the head-mounted display device was in a short-time large-amplitude motion at the previous historical time relative to the current time, and the head-mounted display device is a small-amplitude motion at the current time, i.e., at the previous historical time relative to the current time, the user had the need to view the outside real world or view an image that cannot be seen at the current orientation, while at the current time, the user does not have the need to view the outside real world or view an image that cannot be seen at the current orientation. Thus, the third preset operating mode may be used as the target operating mode corresponding to the current time. The use of the third preset operating mode allows the orientation for processing the display image of a head-mounted display device to slowly change to the target orientation required for the first preset operating mode, so that the user can subsequently watch videos in the first preset operating mode, thereby ensuring the user experience when the user watches videos.

If the motion state corresponding to the current time is the first preset motion state, the motion state corresponding to the previous historical time relative to the current time is the third preset motion state, and the target information characterizes the orientation error between the first estimated orientation and the second estimated orientation as satisfying the preset condition, it indicates that the head-mounted display device was in a long-time large-amplitude motion at the previous historical time relative to the current time, the head-mounted display device is in a small-amplitude motion at the current time, and the current estimated orientation of the head-mounted display device is sufficiently close to the estimated orientation at the last time of the first preset operating mode. Thus, the third preset operating mode may be used as the target operating mode corresponding to the current time. The use of the third preset operating mode allows the orientation for processing the display image of the head-mounted display device to slowly change to the target orientation required for the first preset operating mode, so that the user can subsequently watch videos in the first preset operating mode, thereby ensuring the user experience when the user watches videos.

In still other optional implementations, determining the target operating mode adapted to the head-mounted display device at the current time based on the motion state corresponding to the current time includes:
in response to the motion state corresponding to the current time being one of the second preset motion state and the third preset motion state, using the second preset operating mode as the target operating mode corresponding to the current time.

If the motion state corresponding to the current time is one of the second preset motion state and the third preset motion state, the head-mounted display device may be determined to be in a large-amplitude motion at the current time, i.e., at the current time, the user has the need to view the outside real world or view an image that cannot be seen at the current orientation. Thus, the second preset operating mode may be used as the target operating mode corresponding to the current time, which may be understood as that the orientation of the display image relative to the reference coordinate system substantially remain the orientation before the present mode switching, and does not change with the change of the user's head orientation. Through the use of the second preset operating mode, the real need of the user can be well satisfied.

In conjunction with the above implementations, it can be seen that with reference to the motion state corresponding to the current time and the mode determination reference information, the target operating mode corresponding to the current time can be reasonably determined, the user's needs for watching videos, viewing the outside real world or viewing an image that cannot be seen at the current orientation can be satisfied, and substantial jitter in the display image can be avoided. In specific implementation, the mode determination reference information may also be disregarded, and the target operating mode corresponding to the current time may be determined only on the basis of the motion state corresponding to the current time, or the target operating mode corresponding to the current time may be determined on the basis of motion states corresponding to a plurality of historical times prior to the current time and target operating modes corresponding to the plurality of historical times prior to the current time.

It is to be noted that described above is a case in which the target operating mode corresponding to the current time is automatically determined with reference to the motion state corresponding to the current time as well as other information, and in specific implementation, the target operating mode corresponding to the current time may also be specified by the user.

In some optional examples, as shown in FIG. 5, the method according to embodiments of the present disclosure further includes steps 410, 420 and 430.

Step 410: decomposes the orientation error between the first estimated orientation and the second estimated orientation into a three-axis angular error.

Step 420: in response to three angular errors of the three-axis angular error being all less than a corresponding error threshold, determining target information for characterizing that the orientation error between the first estimated orientation and the second estimated orientation satisfies a preset condition.

Step 430: in response to at least one angular error of the three-axis angular error being greater than or equal to the corresponding error threshold, determining target information for characterizing that the orientation error between the first estimated orientation and the second estimated orientation does not satisfy the preset condition.

In embodiment of the present disclosure, by decomposing the orientation error between the first estimated orientation and the second estimated orientation, the three-axis angular error may be obtained. The three-axis angular error may include a pitch angle error error_{pitch}, a yaw angle error error_{yaw}, and a roll angle error errorᵣₒₗₗ. In addition, a pitch angle error threshold thr_{pitch}, a yaw angle error threshold thr_{yaw}, and a roll angle error threshold thrᵣₒₗₗ may be set in advance.

If error_{pitch} is smaller than thr_{pitch}, error_{yaw} is smaller than thr_{yaw}, and errorᵣₒₗₗ is smaller than thrᵣₒₗₗ, it may be determined that the angular errors obtained by the decomposition are all relatively small, then the first estimated orientation may be considered to be sufficiently close to the second estimated orientation, and therefore, the target information may be used to characterize that the orientation error between the first orientation and the second estimated orientation satisfies the preset condition.

If error_{pitch} is greater than or equal to thr_{pitch}, or error_{yaw} is greater than or equal to thr_{yaw}, or errorᵣₒₗₗ is greater than or equal to thrᵣₒₗₗ, it may be determined that at least part of the angular errors obtained by the decomposition is relatively large, then the first estimated orientation may be determined to be not sufficiently close to the second estimated orientation, and therefore, the target information may be used to characterize that the orientation error between the first estimated orientation and the second estimated orientation does not satisfy the preset condition.

In embodiments of the present disclosure, by decomposing the orientation error between the first estimated orientation and the second estimated orientation, and respectively comparing the angular errors obtained by the decomposition with the corresponding error thresholds, the target information can be determined efficiently and reasonably.

Optionally, thresholds in embodiments of the present disclosure may be adjusted dynamically. The thresholds here may include an angular velocity threshold and an error threshold. For example, when the head-mounted display device is located on a movable platform, the thresholds may be adjusted based on a speed of the movable platform. When the movable platform is not started or is paused, the speed is zero or very small, and smaller thresholds may be used. After the movable platform is started with a certain speed, the above-mentioned thresholds may be adjusted to larger thresholds. The speed of the movable platform may be determined based on IMU data of the head-mounted display device or received information from the movable platform. The information from the movable platform may include gear information, information from a wheel odometer, information from a GPS, and so on.

In some optional examples, as shown in FIG. 6, the method according to embodiments of the present disclosure further includes steps 150 and 160.

Step 150: receiving a reset command input by a user.

Step 160: setting the head-mounted display device to the first preset operating mode in response to the reset command, wherein the first target orientation is an orientation for processing a display image of the head-mounted display device at the previous historical time relative to the current time.

If the head-mounted display device is in the second preset operating mode or the third preset operating mode, in some cases, there may be a need to forcibly switch the head-mounted display device to the first preset operating mode. To satisfy the need for switching, the head-mounted display device may have a reset function. The reset function is used to reset the head-mounted display device to the first preset operating mode.

In some optional implementations, the user may initiate a reset command by voice, or the user may initiate the reset command by operating a control identifier, or the user may initiate the reset command via a preset button on a controller, to indicate that the user wants to forcibly switch to the first preset operating mode. At this point, the head-mounted display device may be set to the first preset operating mode. The first target orientation used in this first preset operating mode may be the orientation for processing the display image of the head-mounted display device at the previous historical time relative to the current time, which is equivalent to using the orientation for processing the display image of the head-mounted display device at the previous historical time relative to the current time as the orientation used in the present first preset operating mode. The orientation is continuously used in the present first preset operating mode.

That is, the target orientation adopted first after forcibly switching to the first preset operating mode is the orientation adopted for processing the display image of the head-mounted display device at the last time of the operating mode before the switching. After forcibly switching to the first preset operating mode, the above-mentioned orientation is used until another operating mode change occurs. The reset command allows the display image to return to the fixed orientation in the device coordinate system of the head-mounted display device. Using a constant-value orientation, the display image may be stabilized at the fixed orientation in the device coordinate system of the head-mounted display device to achieve a 0dof display effect.

For example, the operating mode before forcibly switching to the first preset operating mode is the second preset operating mode, and the orientation adopted for processing the display image of the head-mounted display device at the last time of this second preset operating mode is R_{T1}. The orientation R_{T1} may be used as R₀ in the first preset operating mode after the forcible switching. Subsequently, a change in the operating mode to the second preset operating mode occurs, and an orientation adopted for processing the display image of the head-mounted display device in this second preset operating mode is R_{T2}, where R_{T2}=R₀(R₀)⁻¹R_{T}^{t}=R_{T1}(R₀^{t})⁻¹R_{T}^{y}.

For example, the operating mode before forcibly switching to the first preset operating mode is the third preset operating mode, and the orientation adopted for processing the display image of the head-mounted display device at the last time of this third preset operating mode is F(s). The orientation F(s) may be used as R₀ in the first preset operating mode after the forcible switching. Subsequently, a change in the operating mode to the second preset operating mode occurs, and an orientation adopted for processing the display image of the head-mounted display device in this second preset operating mode is R_{T2}, where R_{T2}=R₀(R₀^{t})⁻¹R_{T}^{t}=F(s)(R₀²)⁻¹R_{T}².

Assuming that before executing the reset command, the head-mounted display device is in the second preset operating mode shown in FIG. 2b, if the reset command is executed at this point, the display image is forcibly adjusted to be displayed in the first preset operating mode, as shown in FIG. 2c. In the first preset operating mode achieved by the reset command, the orientation for processing the display image of the head-mounted display device is always the last orientation for processing the display image of the head-mounted display device in the second preset operating mode shown in FIG. 2b, and the image is maintained at the state in FIG. 2c.

It may be understood that the motion state of the head-mounted display device in the reference coordinate system is not considered in the reset function. Regardless of the motion state of the head-mounted display device, once the reset function is enabled, the first preset operating mode is directly executed. An estimated orientation (i.e., a second estimated orientation) of the head-mounted display device in the reference coordinate system at this time may also be recorded. In subsequent operations, if the reset function is not enabled, the target operating mode adapted to the head-mounted display device may be determined again by determining the motion state of the head-mounted display device in the reference coordinate system. For example, when a certain condition is satisfied, it may be switched to the second preset operating mode shown in FIG. 2d. Afterwards, when the user's orientation returns to the orientation of FIG. 2c and a corresponding judgment condition is satisfied, it may return to the first preset operating mode shown in FIG. 2c.

In embodiments of the present disclosure, the head-mounted display device may be forcibly reset to the first preset operating mode according to a switching requirement in response to the reset command, and a suitable orientation is used in this first preset operating mode. This can ensure that when the user wants the display image to return to a position suitable for the user to view (e.g., directly in front of the user), the display image automatically returns to the position, thereby ensuring the display effect.

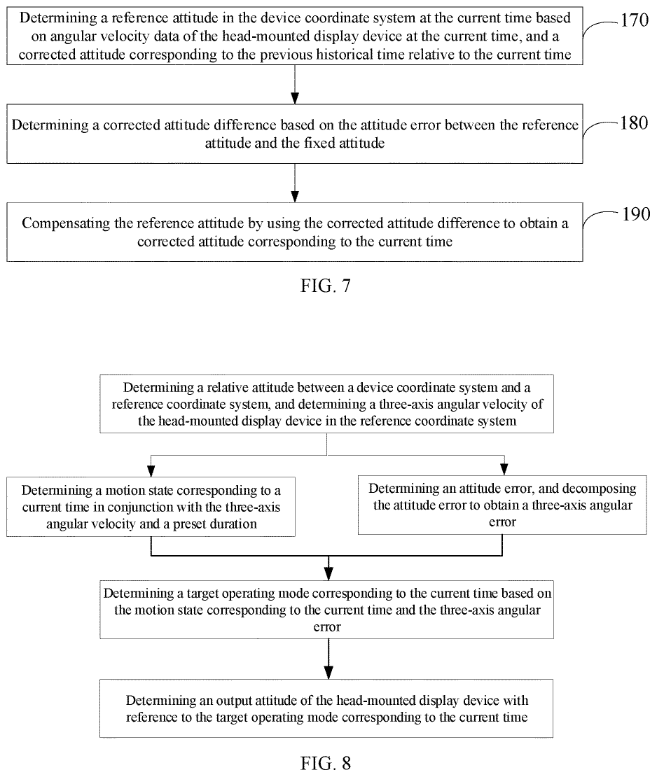

In some optional examples, as shown in FIG. 7, the method according to embodiments of the present disclosure further includes steps 170, 180 and 190.

Step 170: determining a reference orientation in the device coordinate system at the current time based on angular velocity data of the head-mounted display device at the current time, and a corrected orientation corresponding to the previous historical time relative to the current time.

Before step 170, the angular velocity data from the IMU provided in the head-mounted display device may be obtained, and the corrected orientation corresponding to the previous historical time relative to the current time may be obtained. If the current time is a time that is the first to execute the method in embodiments of the present disclosure, the fixed orientation described above or a pre-customized other orientation may be used as the corrected orientation corresponding to the previous historical time relative to the current time. If the current time is a time that is not the first to execute the method in embodiments of the present disclosure, the corrected orientation corresponding to the previous historical time relative to the current time may be determined in a manner similar to that of determining the corrected orientation corresponding to the current time. For specific details, reference may be made to the following description of the manner of determining the corrected orientation corresponding to the current time, which is not set forth here.

Assuming that the angular velocity data of the head-mounted display device at the current time is denoted as Gyroₓ, the corrected orientation corresponding to the previous historical time relative to the current time is denoted as Posesₖ₋₁, and the reference orientation is denoted as Pos̅eₖ, then:

$$\tilde{{Pose}_{k}} = {Pose}_{k - 1} ⊕ {Gyro}_{k}$$

Step 180: determining a corrected orientation difference based on an orientation error between the reference orientation and the fixed orientation.

In step 180, a difference may be calculated between the reference orientation and the fixed orientation to obtain an orientation error between the reference orientation and the fixed orientation. Assuming that the reference orientation is denoted as Pos̅eₖ, the fixed orientation is denoted as Target, and the orientation error is denoted as error, then:

$$error = Target ⊖ \tilde{{Pose}_{k}}$$

In some optional embodiments, after the orientation error is obtained, low pass filter processing can be performed on the orientation error to obtain a corrected orientation difference.

In some other optional embodiments, after the orientation error is obtained, the orientation error can be multiplied by a correction proportional coefficient, and the multiplication result is taken as the corrected orientation difference. Optionally, the correction proportional coefficient may be greater than 0 and less than 1, such as 0.2, 0.6, 0.6, 0.8, etc., which will not be enumerated one by one herein.

step 190: compensating the reference orientation by using the corrected orientation difference to obtain a corrected orientation corresponding to the current time.

In step 190, the corrected orientation difference may be updated as a compensation value to the reference orientation to obtain the corrected orientation corresponding to the current time. Assuming that the corrected orientation corresponding to the current time is denoted as Pos̅eₖ, then:

$${Pose}_{k} = \tilde{{Pose}_{k}} ⊕ {error}_{1}$$

It is to be noted that the compensation value here may represent a relative rotation, and updating the compensation value to the reference orientation may be superimposing a relative orientation on the reference orientation to obtain another orientation, which is the corrected orientation corresponding to the current time.

In embodiments of the present disclosure, using angular velocity data of the head-mounted display device at the current time and a corrected orientation corresponding to the previous historical time relative to the current time, a reference orientation can be efficiently and reliably obtained through integral operation. Then, by calculating a difference between the reference orientation and the orientation error, and performing orientation compensation processing, the corrected orientation corresponding to the current time can be efficiently and reliably determined. The determined corrected orientation is used for processing the display image of the head-mounted display device, which is conducive to adjusting the display effect of the head-mounted display device toward a display effect at the fixed orientation, so that the image stability of the head-mounted display device can be ensured regardless of small angle changes (bumps, wobbles, shakes, etc.) occurring during the use of the head-mounted display device or large angle changes (e.g., large angle turns) occurring during the use of the head-mounted display device.

In some optional examples, a displayable image size of the head-mounted display device in the first preset operating mode is greater than that in the second preset operating mode.

For example, for the user at same orientation, the size of the display image viewed by the user in the first preset operating mode is larger than the size of the image viewed in the second preset operating mode.

In embodiments of the present disclosure, by making the displayable image size of the head-mounted display device in the first preset operating mode greater than that in the second preset operating mode, the presentation size of the display image in the first preset operating mode can be larger, which is conducive to ensuring the use experience when the user watches videos.

In some optional examples, as shown in FIG. 8, in embodiments of the present disclosure, a relative orientation (which may include a first estimated orientation, a second estimated orientation, or another orientation in the estimated orientation sequence, as described above) between the device coordinate system and a reference coordinate system may be determined, and a three-axis angular velocity of the head-mounted display device in the reference coordinate system may be determined.

Next, a motion state corresponding to the current time may be determined in conjunction with the three-axis angular velocity and a preset duration. For the specific determination manner, reference may be made to the above relevant description. In addition, the orientation error described above may be determined based on the relative orientation in the above paragraph, and the orientation error may be decomposed to obtain a three-axis angular error.

Afterwards, based on the motion state corresponding to the current time and the three-axis angular error, a target operating mode corresponding to the current time may be determined, and with reference to the target operating mode corresponding to the current time, an output orientation of the head-mounted display device (equivalent to the orientation for processing the display image of the head-mounted display device as described above) is determined.

In an optional example, the head-mounted display device may be set to the first preset operating mode by default, and if the user rapidly lowers or turns his or her head, resulting in a large-amplitude motion of the head-mounted display device, the head-mounted display device may be switched to the N-th second preset operating mode, so that the display image does not block the user's line of sight. Afterwards, when the user's head orientation returns to an orientation at the time of switching from the most recent (N-th) first preset operating mode to the N-th second preset operating mode (corresponding to R₀^{t} in the above description, i.e., an orientation of the head-mounted display device in the reference coordinate system at the time of the most recent (N-th) mode switching), or by means of a reset command, the head-mounted display device may be switched back to the (N+1)-th first preset operating mode. This enables the head-mounted display device to be in a mode suitable for watching a movie. For example, the display image has a large presentation size and is located in front of the user's field of view to improve the user's movie watching experience, in addition to saving computational resources. If the user rapidly lowers or turns his or her head again subsequently, resulting in a large-amplitude motion of the head-mounted display device, the head-mounted display device may be switched to the (N+1)-th first preset operating mode. When the user returns again to an orientation in the (N+1)-th first preset operating mode, which is an orientation of the head-mounted display device in the reference coordinate system at the time of the (N+1)-th mode switching, or an orientation of the head-mounted display device in the reference coordinate system at the time of the reset command described above, the head-mounted display device may be switched back to the (N+2)-th first preset operating mode. Of course, the user may also use the reset command again to switch the head-mounted display device to back to the (N+2)-th first preset operating mode.

An embodiment of the present disclosure provides a method for displaying an image on a head-mounted display device. The implementation of a first preset operating mode is used as an example in the method. The method includes:
determining that a target operating mode adapted to the head-mounted display device at a current time is a first preset operating mode, in response to satisfying one of the following conditions including: three angular velocities of a three-axis angular velocity of the head-mounted display device in a reference coordinate system at the current time being all less than or equal to corresponding angular velocity thresholds, and a target operating mode corresponding to the previous historical time relative to the current time being the first preset operating mode; receiving a reset command input by a user; and
determining a first target orientation as an orientation for processing a display image of the head-mounted display device at the current time, wherein the first target orientation includes at least one of the following three items: a fixed orientation in a device coordinate system of the head-mounted display device, a corrected orientation in the device coordinate system at the current time, and an orientation used for processing a display image of the head-mounted display device at the previous historical time relative to the current time.

An embodiment of the present disclosure provides a method for displaying an image on a head-mounted display device. The implementation of a second preset operating mode is used as an example in the method. The method includes:
in response to at least one angular velocity of a three-axis angular velocity of the head-mounted display device in a reference coordinate system being greater than a corresponding angular velocity threshold during a time period with the current time as an ending time, determining a target operating mode corresponding to a current time as a second preset operating mode;
determining a second target orientation in a reference coordinate system as an orientation for processing a display image of the head-mounted display device at the current time, wherein the second target orientation is determined based on an orientation error between a first estimated orientation and a second estimated orientation, wherein the first estimated orientation is an estimated orientation of the head-mounted display device in the reference coordinate system at the current time; and the second estimated orientation is an estimated orientation of the head-mounted display device in the reference coordinate system at a target historical time, the target historical time being a historical time that is closest to the current time among historical times at which a corresponding target operating mode is the first preset operating mode; and
based on the orientation for processing the display image of the head-mounted display device at the current time, processing the display image of the head-mounted display device to perform image display through the head-mounted display device.

Any method for displaying an image on a head-mounted display device provided in embodiments of the present disclosure may be executed by any suitable device having data processing capabilities, including, but not limited to a terminal device and a server, etc. Alternatively, any method for displaying an image on a head-mounted display device provided in embodiments of the present disclosure may be executed by a processor. For example, the processor executes any method for displaying an image on a head-mounted display device mentioned in embodiments of the present disclosure, by calling corresponding instructions stored in a memory. This will not be described here.

### Exemplary Apparatus

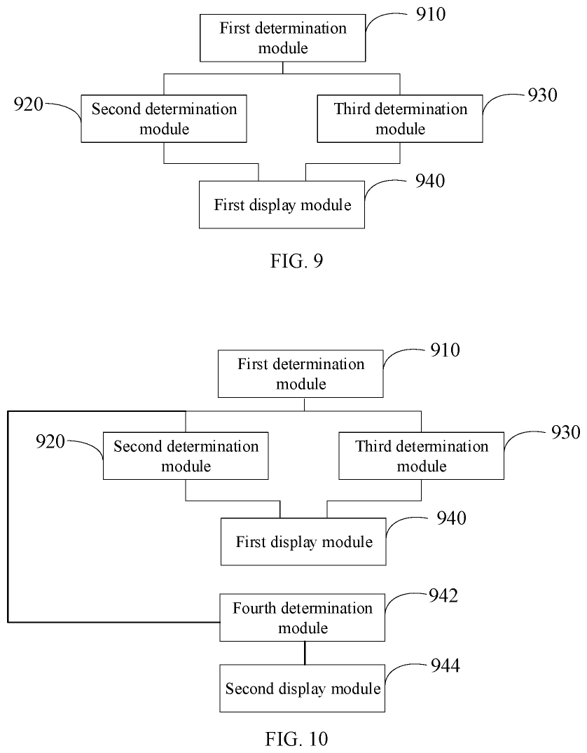

FIG. 9 is a structural diagram of an apparatus for displaying an image on a head-mounted display device according to an exemplary embodiment of the present disclosure. The apparatus shown in FIG. 9 includes a first determination module 910, a second determination module 920, a third determination module 930, and a first display module 940. The first determination module 910 is configured to determine a target operating mode adapted to the head-mounted display device at a current time; the second determination module 920 is configured to, in response to the target operating mode corresponding to the current time being a first preset operating mode, determine a first target orientation as an orientation for processing a display image of the head-mounted display device at the current time, wherein the first target orientation includes at least one of the following three items: a fixed orientation in a device coordinate system of the head-mounted display device, a corrected orientation in the device coordinate system at the current time, and an orientation for processing a display image of the head-mounted display device at the previous historical time relative to the current time; the third determination module 930 is configured to in response to the target operating mode corresponding to the current time being a second preset operating mode, determine a second target orientation in a reference coordinate system as the orientation for processing the display image of the head-mounted display device at the current time, wherein the second target orientation is determined based on an orientation error between a first estimated orientation and a second estimated orientation, wherein the first estimated orientation is an estimated orientation of the head-mounted display device in the reference coordinate system at the current time; and the second estimated orientation is an estimated orientation of the head-mounted display device in the reference coordinate system at a target historical time, the target historical time being a historical time that is closest to the current time among historical times at which a corresponding target operating mode is the first preset operating mode; and the first display module 940 is configured to, based on the orientation for processing the display image of the head-mounted display device at the current time, process the display image of the head-mounted display device to perform image display through the head-mounted display device.

In some optional examples, a first multiplication result of an inverse matrix of the second estimated orientation and the first estimated orientation is used to characterize the orientation error between the first estimated orientation and the second estimated orientation, and the second target orientation satisfies one of the following two conditions: the first target orientation is the orientation for processing the display image of the head-mounted display device at the previous historical time relative to the current time, and a second multiplication result of the first target orientation and the first multiplication result is used as the second target orientation; and the first target orientation is the fixed orientation in the device coordinate system of the head-mounted display device, the first target orientation is an identity matrix, and the first multiplication result is used as the second target orientation.

In some optional examples, as shown in FIG. 10, the apparatus according to the embodiment of the present disclosure further includes:
a fourth determination module 942 configured to, after determining a target operating mode adapted to the head-mounted display device at a current time, in response to the target operating mode corresponding to the current time being a third preset operating mode, determine that during a first time period with the current time as a starting time, a change rule of the orientation for processing the display image of the head-mounted display device is a gradual change from the second target orientation to the first target orientation; and a second display module 944 configured to process the display image of the head-mounted display device according to the change rule corresponding to the first time period to perform image display through the head-mounted display device.

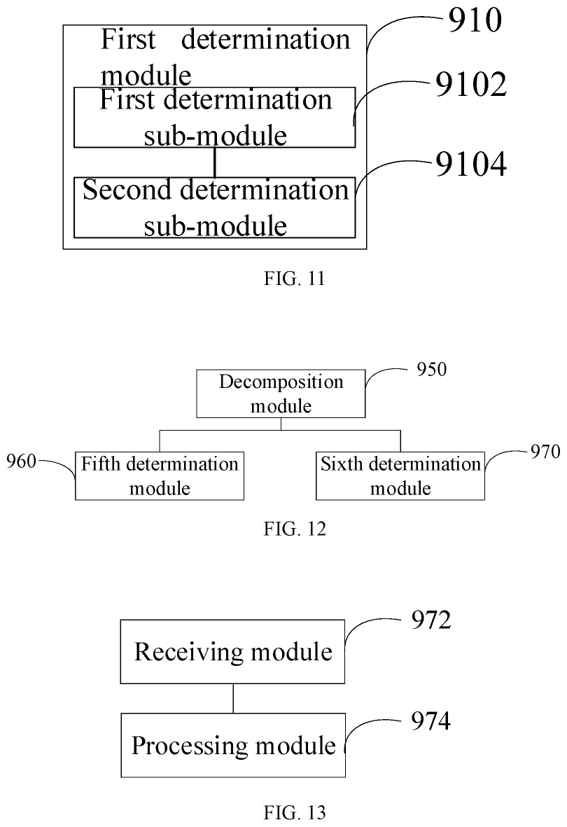

In some optional examples, as shown in FIG. 11, the first determination module 910 includes: a first determination sub-module 9102 configured to determine a motion state of the head-mounted display device in the reference coordinate system at the current time; and a second determination sub-module 9104 configured to determine the target operating mode adapted to the head-mounted display device at the current time based on the motion state corresponding to the current time.

In some optional examples, the second determination sub-module 9104 is specifically configured to, determine the target operating mode corresponding to the current time based on the motion state corresponding to the current time and mode determination reference information, wherein the mode determination reference information includes at least one of the following three items: a target operating mode corresponding to the previous historical time relative to the current time, a motion state corresponding to the previous historical time relative to the current time, and target information used to characterize whether the orientation error between the first estimated orientation and the second estimated orientation satisfies a preset condition.

In some optional examples, the first determination sub-module 9102 includes: a third determination sub-module configured to, in response to three angular velocities of a three-axis angular velocity of the head-mounted display device in the reference coordinate system at the current time being all less than or equal to corresponding angular velocity thresholds, use a first preset motion state as the motion state corresponding to the current time; a fourth determination sub-module configured to, in response to at least one angular velocity of the three-axis angular velocity of the head-mounted display device in the reference coordinate system being greater than a corresponding angular velocity threshold during a second time period with the current time as an ending time, use a second preset motion state as the motion state corresponding to the current time, wherein a duration of the second time period is less than a preset duration; and a fifth determination sub-module configured to, in response to at least one angular velocity of the three-axis angular velocity of the head-mounted display device in the reference coordinate system being greater than a corresponding angular velocity threshold during a third time period with the current time as an ending time, use a third preset motion state as the motion state corresponding to the current time, wherein a duration of the third time period is greater than or equal to the preset duration.

In some optional examples, the second determination sub-module 9104 includes one of the following two units: a first determination unit configured to, in response to the motion state corresponding to the current time being the first preset motion state and the target operating mode corresponding to the previous historical time relative to the current time being the first preset operating mode, use the first preset operating mode as the target operating mode corresponding to the current time; and a second determination unit configured to, in response to the motion state corresponding to the current time being the first preset motion state, the target operating mode corresponding to the previous historical time relative to the current time being the third preset operating mode, and the fact that for the target operating mode corresponding to the previous historical time relative to the current time, a change in the orientation for processing the display image of the head-mounted display device according to a corresponding change rule has completed, use the first preset operating mode as the target operating mode corresponding to the current time.

In some optional examples, the second determination sub-module 9104 includes one of the following two units: a third determination unit configured to, in response to the motion state corresponding to the current time being the first preset motion state and the motion state corresponding to the previous historical time relative to the current time being the second preset motion state, use the third preset operating mode as the target operating mode corresponding to the current time; and a fourth determination unit configured to, in response to the motion state corresponding to the current time being the first preset motion state, the motion state corresponding to the previous historical time relative to the current time being the third preset motion state, and the target information characterizing the orientation error between the first estimated orientation and the second estimated orientation as satisfying the preset condition, use the third preset operating mode as the target operating mode corresponding to the current time.

In some optional examples, the second determination sub-module 9104 is specifically configured to, in response to the motion state corresponding to the current time being one of the second preset motion state and the third preset motion state, use the second preset operating mode as the target operating mode corresponding to the current time.

In some optional examples, as shown in FIG. 12, the apparatus according to the embodiment of the present disclosure further includes: a decomposition module 950 configured to decompose the orientation error between the first estimated orientation and the second estimated orientation into a three-axis angular error; a fifth determination module 960 configured to, in response to three angular errors of the three-axis angular error being all less than a corresponding error threshold, determine target information for characterizing that the orientation error between the first estimated orientation and the second estimated orientation satisfies a preset condition; and a sixth determination module 970 configured to, in response to at least one angular error of the three-axis angular error being greater than or equal to the corresponding error threshold, determine target information for characterizing that the orientation error between the first estimated orientation and the second estimated orientation does not satisfy the preset condition.

In some optional examples, as shown in FIG. 13, the apparatus according to the embodiment of the present disclosure further includes: a receiving module 972 configured to receive a reset command input by a user; and a processing module 874 configured to set the head-mounted display device to the first preset operating mode in response to the reset command, wherein the first target orientation is an orientation for processing a display image of the head-mounted display device at the previous historical time relative to the current time.

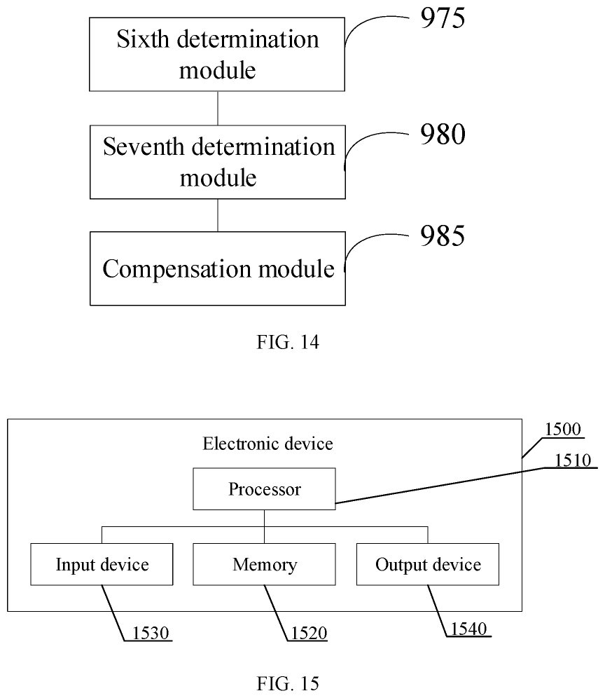

In some optional examples, as shown in FIG. 14, the apparatus according to the embodiment of the present disclosure further includes: a sixth determination module 975 configured to determine a reference orientation in the device coordinate system at the current time based on angular velocity data of the head-mounted display device at the current time, and a corrected orientation corresponding to the previous historical time relative to the current time; a seventh determination module 980 configured to determine a corrected orientation difference based on an orientation error between the reference orientation and the fixed orientation; and a compensation module 985 configured to compensate the reference orientation by using the corrected orientation difference to obtain a corrected orientation corresponding to the current time.

In some optional examples, a displayable image size of the head-mounted display device in the first preset operating mode is greater than that in the second preset operating mode.

In some optional examples, the reference coordinate system includes at least one of the following three items: a world coordinate system; a platform coordinate system of a movable platform where the head-mounted display device is located; and a portable device coordinate system of a portable device communicatively connected to the head-mounted display device.

In the apparatus of the present disclosure, the various optional embodiments, optional implementations, and optional examples disclosed above can all be flexibly selected and combined as needed to achieve corresponding functions and effects, which will not be listed here.

### Exemplary Electronic Device

An electronic device according to an embodiment of the present disclosure will be described below with reference to FIG. 15. The electronic device may be either or both of a first device and a second device, or a stand-alone device independent thereof. The stand-alone device may communicate with the first device and the second device to receive collected input signals therefrom.

FIG. 15 illustrates a block diagram of an electronic device 1500 according to an embodiment of the present disclosure.

As shown in FIG. 15, the electronic device 1500 includes one or more processors 1510 and a memory 1520.

The processor 1510 may be a central processing unit (CPU) or other form of processing unit having data processing capabilities and/or instruction execution capabilities, and may control other components in the electronic device 1500 to perform desired functions.

The memory 1520 may include one or more computer program products. The computer program products may include various forms of computer-readable storage medium, such as a volatile memory and/or a non-volatile memory. The volatile memory may, for example, include random access memory (RAM) and/or a cache memory (cache), etc. The non-volatile memory may, for example, include a read-only memory (ROM), a hard disk, a flash memory, etc. One or more computer program instructions may be stored on the computer-readable storage medium, and the processor 1510 may execute the program instructions to implement the method for displaying an image on a head-mounted display device in the embodiments of the present disclosure described above and/or other desired functions. Various contents such as input signals, signal components, noise components, etc. may also be stored in the computer-readable storage medium.

In an example, the electronic device 1500 may further include input device 1530 and output device 1540. The components are interconnected via a bus system and/or other form of connecting mechanisms (not shown).

For example, in the case where the electronic device 1500 is a first device or a second device, the input device 1530 may be a microphone or a microphone array. In the case where the electronic device 1500 is a stand-alone device, the input device 1530 may be a communication network connector configured to receive acquired input signals from the first device and the second device.

In addition, the input device 1530 may also include, for example, a keyboard, a mouse, and the like.

The output device 1540 may output various information to the outside. The output device 1540 may include, for example, a display, a speaker, a printer, and a communications network and remote output device connected thereto, and so on.

Of course, for simplicity, only some of components of the electronic device 1500 relevant to the present disclosure are shown in FIG. 15, while components such as buses, input/output interfaces, and the like are omitted. In addition, depending on a specific application, the electronic device 1500 may further include any other appropriate components.

### Exemplary Computer Program Product and Computer-Readable Storage Medium

In addition to the method and device described above, embodiments of the present disclosure may also be a computer program product including computer program instructions. The computer program instructions, when executed by a processor, cause the processor to execute the steps of the method for displaying an image on a head-mounted display device according to various embodiments of the present disclosure as described in the above-described “Exemplary method” section of this specification.

The computer program product may use any combination of one or more programming languages to write program code for performing operations of the embodiments of the present disclosure. The programming languages include an object-oriented programming language such as Java or C++, and also include a conventional procedural programming language, such as “C” language or a similar programming language. The program code may be executed entirely on a user's computing device, partly on a user's device, as an independent software package, partly on a user's computing device and partly on a remote computing device, or entirely on a remote computing device or server.

In addition, embodiments of the present disclosure may also be a computer-readable storage medium configured to store computer program instructions therein. The computer program instructions, when executed by a processor, cause the processor to execute the steps of the method for displaying an image on a head-mounted display device according to various embodiments of the present disclosure as described in the above-described “Exemplary method” section of this specification.

The computer-readable storage medium may be any combination of one or more readable media. The readable medium may be a readable signal medium or a readable storage medium. The readable storage medium may include, for example, but is not limited to, an electronic, magnetic, optical, electromagnetic, infrared, or semiconductor system, apparatus or device, or any combination thereof. More specific examples (a non-exhaustive list) of the readable storage medium include: an electrical connection with one or more conducting wires, a portable disk, a hard disk, a random access memory (RAM), a read only memory (ROM), an erasable programmable read only memory (EPROM or flash memory), an optical fiber, a portable compact disk read only memory (CD-ROM), an optical storage device, a magnetic storage device, or any suitable combination thereof.

Basic principles of the present disclosure are described above in conjunction with specific embodiments. However, it is to be noted that the advantages, strengths, effects, and the like mentioned in the present disclosure are only examples and not limitations, and these advantages, strengths, effects, and the like should not be regarded as indispensable for the embodiments of the present disclosure. In addition, the specific details in the above disclosure are only for the purposes of exemplification and ease of understanding, and are not limiting. The above details do not constrain the present disclosure to be necessarily implemented with the above specific details.

The embodiments in the specification are described in a progressive manner. Each embodiment focuses on differences from other embodiments. For the same and similar parts between the embodiments, reference can be made to each other. A system embodiment, which substantially corresponds to a method embodiment, is described relatively simply, and for its relevant parts, reference may be made to parts of description of the method embodiment.

Block diagrams of devices, apparatuses, equipment, and systems involved in the present disclosure are only used as illustrative examples and are not intended to require or imply that they are necessarily connected, arranged, or configured in the manner illustrated in the block diagrams. As will be recognized by those skilled in the art, these devices, apparatuses, equipment, and systems may be connected, arranged, or configured in any manner. Words such as “include”, “comprise”, “have”, etc. are open-ended terms, mean “include but not limited to” and may be used interchangeably. The words “or” and “and” as used herein refer to the words “and/or”, and may be used interchangeably therewith unless the context clearly indicates otherwise. The word “such as” as used herein refers to the phrase “such as, but not limited to”, and may be used interchangeably therewith.

The method and apparatus of the present disclosure may be implemented in many ways. For example, the method and apparatus of the present disclosure may be implemented by software, hardware, firmware, or any combination of software, hardware, and firmware. The above order for the steps of the described method is only for an illustrative purpose, and the steps of the methods of the present disclosure are not limited to the order specifically described above, unless otherwise specified. Additionally, in some embodiments, the present disclosure may also be implemented as programs recorded in a recording medium. The programs include machine-readable instructions for implementing the method according to the present disclosure. Thus, the present disclosure also covers a recording medium that stores programs for performing the method according to the present disclosure.

It is also to be noted that in the apparatus, device, and method of the present disclosure, the components or steps are decomposable and/or recombinable. These decompositions and/or recombinations should be considered as equivalents of the present disclosure.

The above description of the disclosed aspects is provided to enable any person skilled in the art to carry out or use the present disclosure. Various modifications to these aspects are very apparent to those skilled in the art, and general principles defined herein may be applied to other aspects without departing from the scope of the present disclosure. Accordingly, the present disclosure is not intended to be limited to the aspects illustrated herein, but rather in accordance with the broadest scope consistent with the principles and novel features disclosed herein.

The above description has been made for purposes of illustration and description. In addition, this description is not intended to limit the embodiments of the present disclosure to the forms disclosed herein. Although a plurality of example aspects and embodiments have been discussed above, certain variations, modifications, changes, additions, and sub-combinations thereof would occur to those skilled in the art.

1. A method for displaying an image on a head-mounted display device, comprising:
determining a target operating mode adapted to the head-mounted display device at a current time;
in response to the target operating mode corresponding to the current time being a first preset operating mode, determining a first target orientation as an orientation for processing a display image of the head-mounted display device at the current time, wherein the first target orientation comprises at least one of the following three items: a fixed orientation in a device coordinate system of the head-mounted display device, a corrected orientation in the device coordinate system at the current time, and an orientation for processing a display image of the head-mounted display device at a previous historical time relative to the current time;
in response to the target operating mode corresponding to the current time being a second preset operating mode, determining a second target orientation in a reference coordinate system as the orientation for processing the display image of the head-mounted display device at the current time, wherein the second target orientation is determined based on an orientation error between a first estimated orientation and a second estimated orientation, wherein the first estimated orientation is an estimated orientation of the head-mounted display device in the reference coordinate system at the current time; and the second estimated orientation is an estimated orientation of the head-mounted display device in the reference coordinate system at a target historical time, the target historical time being a historical time that is closest to the current time among historical times at which a corresponding target operating mode is the first preset operating mode; and
based on the orientation for processing the display image of the head-mounted display device at the current time, processing the display image of the head-mounted display device to display image through the head-mounted display device.

2. The method according to claim 1, wherein a first multiplication result of an inverse matrix of the second estimated orientation and the first estimated orientation is used to characterize the orientation error between the first estimated orientation and the second estimated orientation, and the second target orientation satisfies one of the following two conditions:
the first target orientation is the orientation for processing the display image of the head-mounted display device at the previous historical time relative to the current time, and a second multiplication result of the first target orientation and the first multiplication result is used as the second target orientation; and
the first target orientation is the fixed orientation in the device coordinate system of the head-mounted display device, the first target orientation is an identity matrix, and the first multiplication result is used as the second target orientation.

3. The method according to claim 1, wherein after determining a target operating mode adapted to the head-mounted display device at the current time, the method further comprises:
in response to the target operating mode corresponding to the current time being a third preset operating mode, determining that during a first time period with the current time as a starting time, a change rule of the orientation for processing the display image of the head-mounted display device is a gradual change from the second target orientation to the first target orientation; and
processing the display image of the head-mounted display device according to the change rule corresponding to the first time period to display image through the head-mounted display device.

4. The method according to claim 1, wherein determining a target operating mode adapted to the head-mounted display device at the current time comprises:
determining a motion state of the head-mounted display device in the reference coordinate system at the current time; and
determining the target operating mode adapted to the head-mounted display device at the current time based on the motion state corresponding to the current time.

5. The method according to claim 4, wherein determining the target operating mode adapted to the head-mounted display device at the current time based on the motion state corresponding to the current time comprises:
determining the target operating mode corresponding to the current time based on the motion state corresponding to the current time and mode determination reference information, wherein the mode determination reference information comprises at least one of the following three items: the target operating mode corresponding to the previous historical time relative to the current time, the motion state corresponding to the previous historical time relative to the current time, and target information used to characterize whether the orientation error between the first estimated orientation and the second estimated orientation satisfies a preset condition.

6. The method according to claim 4, wherein determining a motion state of the head-mounted display device in the reference coordinate system at the current time comprises:
in response to three angular velocities of a three-axis angular velocity of the head-mounted display device in the reference coordinate system at the current time being all less than or equal to corresponding angular velocity thresholds, using a first preset motion state as the motion state corresponding to the current time;
in response to at least one angular velocity of the three-axis angular velocity of the head-mounted display device in the reference coordinate system being greater than a corresponding angular velocity threshold during a second time period with the current time as the ending time, using a second preset motion state as the motion state corresponding to the current time, wherein a duration of the second time period is less than a preset duration; and
in response to at least one angular velocity of the three-axis angular velocity of the head-mounted display device in the reference coordinate system being greater than a corresponding angular velocity threshold during a third time period with the current time as the ending time, using a third preset motion state as the motion state corresponding to the current time, wherein a duration of the third time period is greater than or equal to the preset duration.

7. The method according to claim 6, wherein determining the target operating mode corresponding to the current time based on the motion state corresponding to the current time and mode determination reference information comprises one of the following two items:
in response to the motion state corresponding to the current time being the first preset motion state and the target operating mode corresponding to the previous historical time relative to the current time being the first preset operating mode, using the first preset operating mode as the target operating mode corresponding to the current time; and
in response to the motion state corresponding to the current time being the first preset motion state, the target operating mode corresponding to the previous historical time relative to the current time being the third preset operating mode, and a fact that for the target operating mode corresponding to the previous historical time relative to the current time, a change in the orientation for processing the display image of the head-mounted display device according to a corresponding change rule has completed, using the first preset operating mode as the target operating mode corresponding to the current time.

8. The method according to claim 6, wherein determining the target operating mode corresponding to the current time based on the motion state corresponding to the current time and mode determination reference information comprises one of the following two items:
in response to the motion state corresponding to the current time being the first preset motion state and the motion state corresponding to the previous historical time relative to the current time being the second preset motion state, using the third preset operating mode as the target operating mode corresponding to the current time; and
in response to the motion state corresponding to the current time being the first preset motion state, the motion state corresponding to the previous historical time relative to the current time being the third preset motion state, and the target information characterizing the orientation error between the first estimated orientation and the second estimated orientation as satisfying the preset condition, using the third preset operating mode as the target operating mode corresponding to the current time.

9. The method according to claim 6, wherein determining the target operating mode adapted to the head-mounted display device at the current time based on the motion state corresponding to the current time comprises:
in response to the motion state corresponding to the current time being one of the second preset motion state and the third preset motion state, using the second preset operating mode as the target operating mode corresponding to the current time.

10. The method according to claim 1, wherein the method further comprises:
receiving a reset command input by a user;
setting the head-mounted display device to the first preset operating mode in response to the reset command, wherein the first target orientation is an orientation for processing a display image of the head-mounted display device at the previous historical time relative to the current time.

11. The method according to claim 1, wherein the method further comprises:
determining a reference orientation in the device coordinate system at the current time based on angular velocity data of the head-mounted display device at the current time, and a corrected orientation corresponding to the previous historical time relative to the current time;
determining a corrected orientation difference based on the orientation error between the reference orientation and the fixed orientation; and
compensating the reference orientation by using the corrected orientation difference to obtain a corrected orientation corresponding to the current time.

12. The method according to claim 1, wherein a displayable image size of the head-mounted display device in the first preset operating mode is greater than that in the second preset operating mode.

13. The method according to claim 1, wherein the reference coordinate system comprises at least one of the following three items:
a world coordinate system;
a platform coordinate system of a movable platform where the head-mounted display device is located; and
a portable device coordinate system of a portable device communicatively connected to the head-mounted display device.

14-15. (canceled)

16. The method according to claim 5, further comprising:
decomposing the orientation error between the first estimated orientation and the second estimated orientation into a three-axis angular error.
in response to three angular errors of the three-axis angular error being all less than corresponding error thresholds, determining target information for characterizing that the orientation error between the first estimated orientation and the second estimated orientation satisfies a preset condition.
in response to at least one angular error of the three-axis angular error being greater than or equal to a corresponding error threshold, determining target information for characterizing that the orientation error between the first estimated orientation and the second estimated orientation does not satisfy the preset condition.

17. The method according to claim 3, wherein determining a target operating mode adapted to the head-mounted display device at the current time comprises:
determining a motion state of the head-mounted display device in the reference coordinate system at the current time; and
determining the target operating mode adapted to the head-mounted display device at the current time based on the motion state corresponding to the current time.

18. A method for displaying an image on a head-mounted display device, comprising:
in response to satisfying one of conditions, determining that a target operating mode adapted to the head-mounted display device at a current time is a first preset operating mode, the conditions comprising: three angular velocities of a three-axis angular velocity of the head-mounted display device in a reference coordinate system at the current time being all less than or equal to corresponding angular velocity thresholds, and a target operating mode corresponding to a previous historical time relative to the current time being the first preset operating mode; and receiving a reset command input by a user; and
determining a first target orientation as an orientation for processing a display image of the head-mounted display device at the current time, wherein the first target orientation comprises at least one of the following three items: a fixed orientation in a device coordinate system of the head-mounted display device, a corrected orientation in the device coordinate system at the current time, and an orientation used for processing a display image of the head-mounted display device at the previous historical time relative to the current time.

19. The method according to claim 18, wherein the method further comprises:
determining a reference orientation in the device coordinate system at the current time based on angular velocity data of the head-mounted display device at the current time, and a corrected orientation corresponding to the previous historical time relative to the current time;
determining a corrected orientation difference based on the orientation error between the reference orientation and the fixed orientation; and
compensating the reference orientation by using the corrected orientation difference to obtain a corrected orientation corresponding to the current time.

20. The method according to claim 18, wherein the reference coordinate system comprises at least one of the following three items:
a world coordinate system;
a platform coordinate system of a movable platform where the head-mounted display device is located; and
a portable device coordinate system of a portable device communicatively connected to the head-mounted display device.

21. A method for displaying an image on a head-mounted display device, the method comprising:
in response to at least one angular velocity of a three-axis angular velocity of the head-mounted display device in a reference coordinate system being greater than a corresponding angular velocity threshold during a time period with the current time as an ending time, determining a target operating mode corresponding to a current time as a second preset operating mode;
determining a second target orientation in a reference coordinate system as an orientation for processing a display image of the head-mounted display device at the current time, wherein the second target orientation is determined based on an orientation error between a first estimated orientation and a second estimated orientation, wherein the first estimated orientation is an estimated orientation of the head-mounted display device in the reference coordinate system at the current time; and the second estimated orientation is an estimated orientation of the head-mounted display device in the reference coordinate system at a target historical time, the target historical time being a historical time that is closest to the current time among historical times at which a corresponding target operating mode is the first preset operating mode; and
based on the orientation for processing the display image of the head-mounted display device at the current time, processing the display image of the head-mounted display device, to display an image through the head-mounted display device.

22. The method according to claim 21, wherein the reference coordinate system comprises at least one of the following three items:
a world coordinate system;
a platform coordinate system of a movable platform where the head-mounted display device is located; and
a portable device coordinate system of a portable device communicatively connected to the head-mounted display device.
